(19) United States
(12) Patent Application Publication
(10) Pub. No.: US 2007/0192461 A1
(43) Pub. Date: Aug. 16, 2007

(54) SYSTEM AND METHOD FOR DYNAMICALLY GENERATING AND MANAGING AN ONLINE CONTEXT-DRIVEN INTERACTIVE SOCIAL NETWORK

(76) Inventors: Robert Reich, Boulder, CO (US); Peter Newcomb, Boulder, CO (US)

Correspondence Address: COOLEY GODWARD KRONISH LLP;ATTN: Patent Group, Suite 500, 1200 - 19th Street, NW, WASHINGTON, DC, 20036-2402, US

(21) Appl. No.: 11/556,659

(22) Filed: Nov. 3, 2006

Related U.S. Application Data
(60) Provisional application No. 60/734,005, filed on Nov. 3, 2005.
(60) Provisional application No. 60/822,593, filed on Aug. 16, 2006.

(51) Int. Cl. G06F 15/173

(52) U.S. Cl. 709/223

(57) ABSTRACT

A system and method for calculating recommendations for a user is described. One embodiment includes a method for collecting actions performed by a plurality of secondary users; calculating correlations between the collected actions; generating a record of the collected actions and the corresponding calculated correlations; receiving an indication of a first action from a primary user; identify a second action from the generated record that is correlated with the first action; identifying a secondary user from the plurality of secondary users that has performed the second action; determining whether the secondary user is performing a secure action; and if the secondary user is not performing a secure action, providing a recommendation to the primary user, the recommendation including an identification of the secondary user.

### PRIORITY

The present application claims priority to commonly owned and assigned application No. 60/734,005, filed Nov. 3, 2005, Attorney Docket No. 1047-2PROV, entitled SYSTEM AND METHOD FOR DYNAMICALLY GENERATING AND MANAGING AN ONLINE CONTEXT DRIVEN INTERACTIVE SOCIAL NETWORK; and application No. 60/822,593, filed Aug. 16, 2006, Attorney Docket No. MEDM-001/00US, entitled SYSTEM AND METHOD FOR DYNAMICALLY GENERATING AND MANAGING AN ONLINE CONTEXT-DRIVEN INTERACTIVE SOCIAL NETWORK, both of which are incorporated herein by reference.

### RELATED APPLICATIONS

This application is related to commonly owned and assigned application No. (PENDING), MEDM-001/01US, filed simultaneously herewith.

### FIELD OF THE INVENTION

The present invention relates generally to systems and methods for providing and managing on-line user communities and social networks.

### BACKGROUND OF THE INVENTION

Since computer users have first been able to communicate with one another through a telecommunication connection between their computers, there has been a growing desire to utilize computers and telecommunication systems for social interaction with others. While e-mail provided one-to-one communication with the advent of dial-in bulletin board systems (BBS) in the early 1980s, computer users discovered the joy of being able to communicate with many other users at once. Most of the early BBSs were either dedicated to particular interests or were used by groups of friends or other types of socially connected individuals.

In recent years, the popularity of the Word Wide Web (WWW) coupled with incredible growth in availability and accessibility of high bandwidth Internet connections resulted in an unprecedented proliferation of “on-line communities.” These phenomena include, but are not limited to, chat-rooms, on-line forums, groups, clubs, and digital photograph-sharing websites. In particular, on-line “portals” that provided WWW users with a variety of services (e.g., searching, news, free-email, etc.) immediately recognized the great value of hosting (i.e., providing storage resources and administration tools to) such communities. The more time the users spent using the communities, the greater their exposure to the hosting portal's advertising and other offered fee-based services.

As a natural extension of the concept of on-line communities there have been many efforts to translate the benefits of multiple-interest groups of users into advantageous business models or to otherwise utilize them for commercial purposes. These efforts typically took several different approaches: (1) websites for digital image sharing and management, (2) on-line merchant systems utilizing user-feedback for making product or service recommendations based on feedback received from other users with similar interests (also known as collaborative filtering), (3) systems that facilitate on-line and real-world social activities, such as event-planning and contact management websites; (4) dating websites which attempt to match users to one another using a number of different techniques; and most commonly “forum” style communities or web logs (“blogs”) where in addition to content users could interact with one another through topic-related posts or through chatting.

However, all of the above approaches suffer from a number of disadvantages:

1) Most of them were add-ons to, and/or functioned separately from, the on-line communities while those functions that were integrated into the community systems did not provide sophisticated features (e.g., robust and full-featured contact management, event planning and others were separate systems from the on-line community systems that had basic photo albums, calendars, and member contact lists);

2) The users had to learn how each system worked and had to keep track of what they did with which system (e.g., one website used for automatic contact management, another for photo sharing, and a third one for on-line social activity);

3) For the community or related service to grow, new users had to be attracted through advertising or more often by invitation from existing users; and

4) Most importantly, all of the approaches required the users to make significant efforts to take advantage of their features, with a greater desired quantity and quality level of features requiring a greater effort on the part of the user (e.g., to get movie recommendations, the user had to rate many movies themselves, or had to identify his friends as contacts for a contact management and/or event planning website).

The fourth disadvantage noted above has been the greatest barrier to further evolution of on-line communities and related services/functions. It is well known that the attention span of an average on-line user is tiny. In fact, the very reason that the portals are constantly developing new services and features, is to keep the users on their websites as long as possible. Accordingly, providing the information to a system to take advantage of its features often took more effort that most users were willing to put in, and the users either ignored the service or feature, or more often gave up before all necessary information was provided, and then disparaged the “poor quality” of the feature. Also the growth of virtually all communities (aside from Adult-oriented ones) has been relatively slow after rapid initial growth, as new users are becoming harder and harder to attract. Even though, in the last few years, new developments in the online communities called “social networks” have solved at least some of the above disadvantages, the key challenge of lack of desire by users to make active efforts to contribute to system functionality, remains unanswered.

Additionally, in recent years, searching for specific relevant content has become an arduous task because many search engines utilize algorithms that can be readily manipulated by their parties to push their content to the forefront of results presented to the searcher typically with little regard for relevance. Thus, a user searching for information on a LCD monitor would be bombarded with dozens of results of stores and price-comparison sites-significant time is then required to sift through the content to locate a relevant website with a review. Other forms of searching content (category browsing, community based, etc,) have other disadvantages. In each approach, the user must expend significant effort to seek out and identify relevant content.

It would thus be desirable to provide a system and method for forming social communities implemented in content-based online networks that automatically increase in relevance, usefulness, number of features, and functionality as a result of utilization by users thereof. It would also be desirable to provide a system and method for customizing the community experience and functionality based on context-relevance to user's current activities. It would further be desirable to provide a system and method for implementing dynamic community formation processes that automatically improve the scope, quality, and relevance of dynamically formed contextual communities based on data implicitly derived from routine utilization of the system by the users without requiring additional efforts from the users. It would further be desirable to provide a contextual community formation system and method that automatically increases the number and usefulness of features available to a user based on the user's continued participation in interactive featured offered by the system. Other desirable features also exist. These features are described herein.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the particular forms described in this Summary of the Invention or in the Detailed Description. One skilled in the art can recognize that there are numerous modifications, equivalents and alternative constructions that fall within the spirit and scope of the invention as expressed in the claims.

A system and method for calculating recommendations for a user is described. One embodiment includes a method for collecting actions performed by a plurality of secondary users; calculating correlations between the collected actions; generating a record of the collected actions and the corresponding calculated correlations; receiving an indication of a first action from a primary user; identify a second action from the generated record that is correlated with the first action; identifying a secondary user from the plurality of secondary users that has performed the second action; determining whether the secondary user is performing a secure action; and if the secondary user is not performing a secure action, providing a recommendation to the primary user, the recommendation including an identification of the secondary user.

### BRIEF DESCRIPTION OF THE DRAWINGS

In the drawings, wherein like reference characters denote elements throughout the several views:

FIG. 1 illustrates a typical architecture on which embodiments of the present invention could be utilized;

FIG. 2 illustrates another architecture for implementing certain embodiments of the present invention;

FIG. 3 illustrates the modules of software that could be operated by the recommendation generator;

FIG. 4 illustrates an exemplary method for gathering performance data;

FIG. 5 illustrates an exemplary method for gathering performance data from an actor;

FIG. 6 illustrates another exemplary method for gathering performance data from an actor;

FIG. 7 illustrates a method for calculating the importance of the actor's latest performance;

FIG. 8 illustrates one method of calculating the importance of an actor's previous performances;

FIG. 9 illustrates a method of strengthening explicit correlations;

FIG. 10 illustrates an exemplary data structure that could be used with embodiments of the present invention;

FIG. 11 illustrates a method of strengthening the implicit action correlations between an implicit later action and an explicit earlier action;

FIG. 12 illustrates an exemplary data structure that could be used with embodiments of the present invention;

FIG. 13 illustrates a method of strengthening the implicit action correlation;

FIG. 14 illustrates an exemplary data structure that could be used with embodiments of the present invention;

FIG. 15 illustrates an adjustment for multitasking workers that can be implemented in certain embodiments;

FIG. 16 illustrates one method for making a recommendation to an actor using information gathered about an actor's performances; and

FIG. 17 illustrates a method of forming the set of relevant actions.

### DETAILED DESCRIPTION

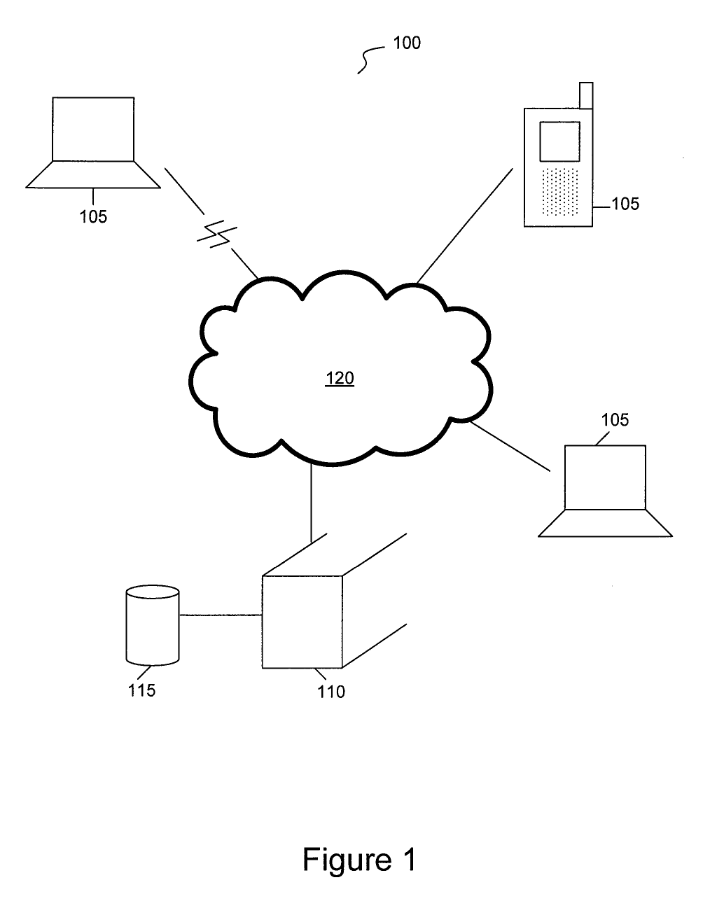

Referring now to the drawings, where like or similar elements are designated with identical reference numerals throughout the several views, and referring in particular to FIG. 1, it illustrates an exemplary architecture 100 on which embodiments of the present invention could be utilized. This embodiment includes users 105, also referred to as “actors,” connected to a server 110 and database 115 through a network 120. In certain instances, the term “actors” includes human users, software, or some combination of the two. The server 110 and database 115 generally contain software for collecting information regarding actors actions and for generating recommendations. The term “action” refers to act(s) performed by actors, act(s) in combination with resources, resource(s), resource(s) in combination with implied acts, and act(s) in combination with implied resources. This software or software-hardware combination is sometimes referred to as the “recommendation engine.” The recommendation engine could be operated on a personal computer or a larger computer system. The actors could use a typical personal computer, a computer terminal, or a mobile device (such as a cell phone or PDA) to access the server and associated database. The network that connects the users to the recommendation generator could be the internet, an intranet, a corporate LAN, or any other type of network.

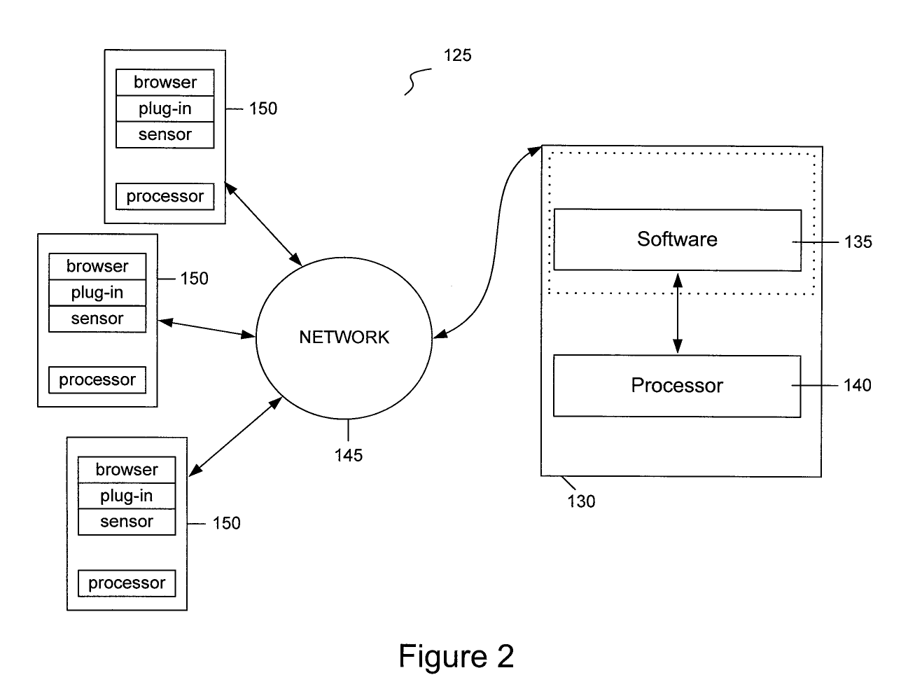

Referring now to FIG. 2, it illustrates another architecture 125 for implementing certain embodiments of the present invention. In this implementation, the server 130 includes recommendation software 135 executing on a processor 140. The server is connected through a network 145 to three actors 150. Each of these actors 150 is operating a computing device that includes a processor executing software. This software includes a browser, a plug-in for extracting information about the actor's actions and sending it to the recommendation software and a sensor for monitoring the actor's actions. The actor's system could include chat programs, instant messaging programs, email programs, word processing programs, and similar programs. The plug-in could collect information about the actor's actions. Other embodiments do not necessary include a plug-in. For example, the actor could be interacting with an ASP, and the ASP would collect the relevant information.

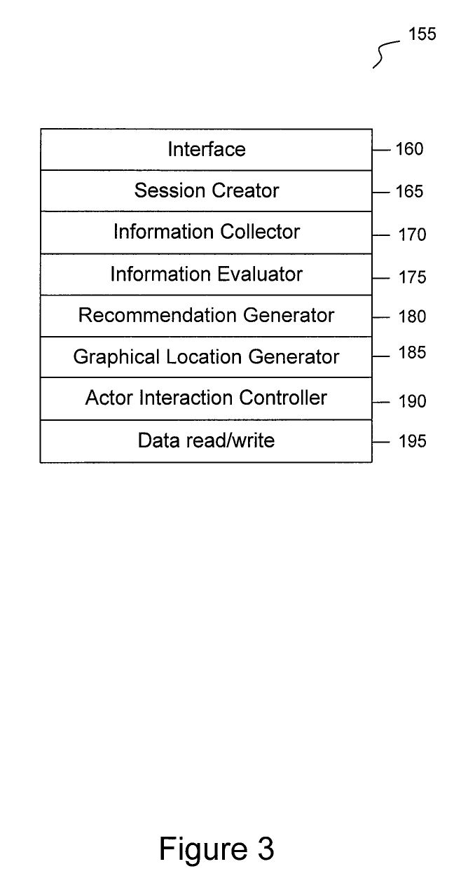

Referring now to FIG. 3, it illustrates exemplary software modules 155 that could make up the recommendation engine. These modules are described according to their functions and could be grouped differently. As those of skill in the art understand, many of these functions could be combined together into one software module and similarly, many of these functions could be divided into several different software modules. These functional modules are described briefly with regard to FIG. 3 and in more detail with regard to the subsequent flow charts.

Referring first to the interface module 160, it is an input-output controller and serves as the interface for actors or the actor's computing devices to interact with the recommendation engine. Similarly, the interface module 160 directs the communications from the recommendation engine to the actors. For example, the interface module 160 could decide which network should be used to communicate with a particular actor.

The second software module shown in FIG. 3 is the session creator 165. The session creator module 165 is designed to create a record block for actors that interact with the recommendation engine. In essence, the session creator module 165 creates a record or log of the actor's actions that are collected by the software at the actor's computer. The session creator module 165 can create short-term session records that reflect what action the actor is performing in a particular window, a particular program, or a particular group of programs. Alternatively, the session creator module 165 could create a long term history for the individual actor reflecting what the actor did over several days or weeks.

The information collector software module 170 is responsible for interacting with the actor's software, including the plug-ins at the user computer, and matching incoming data from the actor with the particular session created by the session creator software. In a typical implementation, the recommendation engine may be interacting with hundreds of thousands of actors simultaneously and the information collector module 170 is responsible for gathering that information and then sorting it according to the appropriate actor or sessions.

Referring now to the information evaluator software module 175, it is responsible for analyzing information collected and sorted by the information collector and analyzing that data to produce a recommendation for a particular user. The information evaluator module 175, for example, correlates records across all the actor and determines which users are performing similar actions to the particular actor seeking the recommendation. The operation of the information evaluator module 175 is described in more detail in the subsequent flow charts.

The next software module in FIG. 3 is the recommendation generator module 180. This module is responsible for identifying community data with the current other actors that are performing actions similar to those being performed by an actor. As with the information evaluator module 175, the operation of this module is described in more detail in subsequent flow charts.

The next module is the graphical location generator module 185. The graphical location generator is responsible for generating graphics that convey to the actor where groups of people are performing similar actions to the actions that that actor is performing. In essence, the graphical location generator is responsible for generating graphics that show crowds or individuals performing certain tasks similar to those performed by the user.

The actor interaction controller module 190 is the software module responsible for controlling communication between various actors. The actor interaction controller module 190 software could include chat programs, email programs, privacy-protection programs, and internet-based phone programs.

The final software module shown in FIG. 3 is the data read-write module 195. This is an input/output controller configured to read and write data to short-term memory and long-term storage.

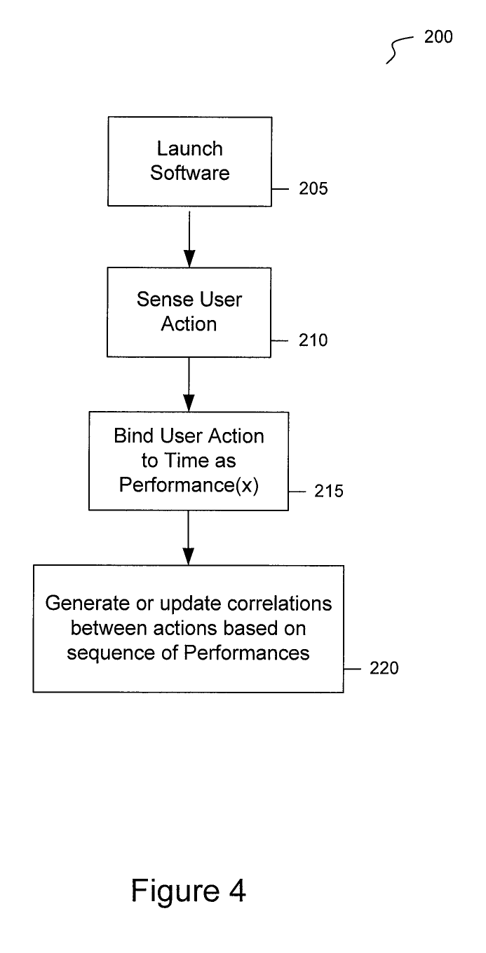

Referring now to FIG. 4, it illustrates an exemplary method 200 for gathering performance data related to an actor. Performance data generally refers at least to an action performed by an actor and the time at which the action was performed. Performance data can be gathered for two purposes: to build community action information and to generate recommendations for a particular actor.

Regarding the first purpose, building community information, performance data is potentially collected from thousands of actors. The identity of the actors is typically, but not always, removed from that data and just the action and time information is stored. This action data reflects the different actions that the various actors in the community typically perform or have recently performed. For the purposes of this document, the term “performance” generally refers at least to a particular action performed by a particular actor at a specific time. For example, a performance would be actor “A” accessing www.cnn.com at a particular time. In this example, the action would be accessing www.cnn.com and the action type would be accessing a web site.

FIG. 4 broadly refers to actions that could take place on the actor's computer or on the recommendation engine. Initially, the actor launches recommendation software. (Block 205) This software could be embedded in the actor's browser or could be a stand-alone plug-in operated on the actor's computing device. The launched software could also be a proprietary search software, an instant messaging program, a chat program, or an email program. Once launched the actor's software will sense actions performed on the computer. (Block 210) For example, the software could sense website navigation, navigation within a particular web page, pauses in activity, opening new windows, sending email, creating graphics, keystrokes, or any other action specific to a particular software program. Once the computer senses these actions and collects data about these actions, that data can be sent to the recommendation engine. The recommendation engine can then bind those actions to a particular time and thereby create a performance which binds a particular action and a particular time. (Block 215) Alternatively, the actor's computer could bind the time to the sensed action and could transmit that performance data to the recommendation engine.

Once the recommendation engine either receives or determines for itself the time that a particular action was performed, the recommendation engine can store that information and generate correlations between particular actions. (Block 220) For example, the recommendation engine could link a actor's previous performance with actor's most recent performance. This information could be stored in a table or other data structure. In essence, the recommendation engine can collect all the actor's performances over a period of time and use those to generate recommendations for future actions based on community activity. Similarly, the list of performances performed by a particular actor can be added to the community information so that others can see the series of actions that this particular actor performed. Typically, community information does not identify particular actors but is rather just a collection of actions performed by members of the community and the correlation between those actions. These processes are described in more detail in the subsequent flow charts.

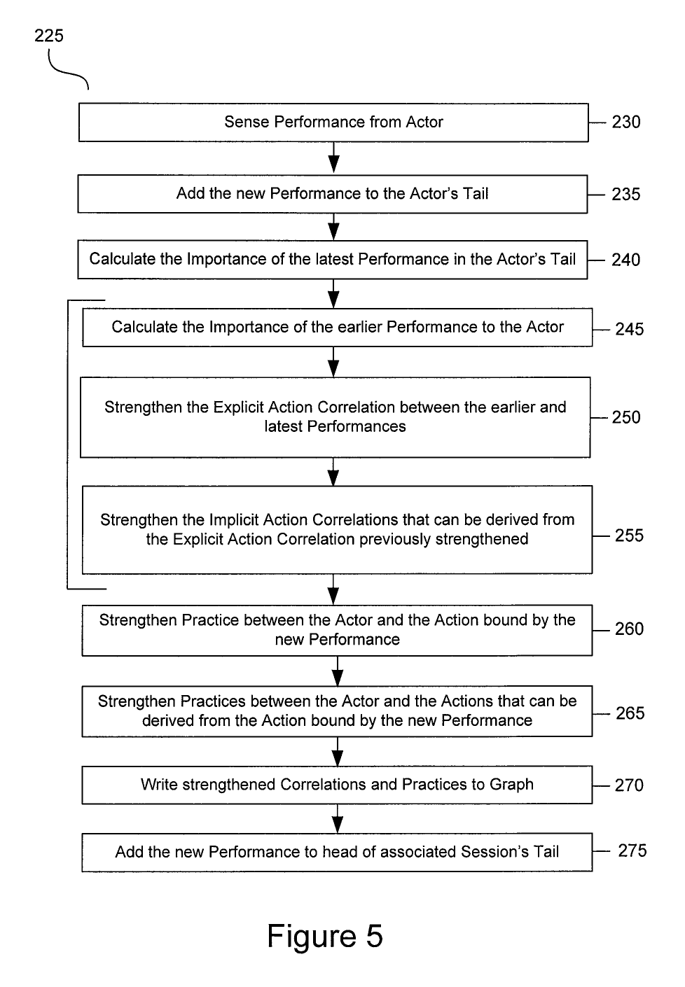

Referring now to FIG. 5, it illustrates an exemplary method 225 for gathering performance data corresponding to an actor. For example, this flow chart illustrates a method for collecting action data and time data with regard to a particular actor. Initially, the actor's computer collects information about an actor's performance. (Block 230) As previously discussed, a performance could be accessing www.cnn.com at a particular time. After the performance, or the corresponding action, is sensed, that performance is added to the actor's tail. (Block 235) The actor's tail is generally the sequence of performances performed by an actor. Alternatively, the tail could be a grouping of performances performed by an actor without regard to time but rather grouped according to context. Stated differently, an actor's tail is generally the sequence of performances performed by an actor arranged by time or by context.

Next, the importance of the latest performance in the actor's tail can be calculated. (Block 240) Typically, the importance of a performance is represented by a number calculated from information available to the system. For example, a performance upon which the actor spends more time might be considered more important than one upon which the actor spends less time. Similarly, certain action types may be more important than other action types. Scrolling down a web page may be more important than rolling over an ad on a web page with a mouse.

The next three blocks (245, 250, 255) perform a loop that is performed on each performance in the actor's tail. For example, if the actor had three performances in his tail, the next three steps would be performed on each performance. The initial block in this loop involves calculating the importance of the earlier performance. (Block 245) This step recalculates the importance of the earlier performances to the actor. The importance data can change because of the time factor. For example, performances performed an hour ago may not be as important as recent performances. Typical importance data includes the time between the earlier performance and the latest performance and the time between the earlier performance and the subsequent performance. This type of data can be factored in to recalculate the importance of the earlier performance to the actor.

Using the calculated performance data of both the latest performance and the earlier performances, the explicit action correlation between the earlier and latest performances can be recalculated. (Block 250) The explicit action correlation is generally a numerical indicator of the correlation between two explicit actions.

Next, the correlations between the explicit actions in the actor's tail and the corresponding implicit actions can be recalculated. (Block 255) An implicit action is typically an action derived from the explicit action by substituting a more generic action type. For example, if an actor access www.cnn.com/tech/space, that would be a particular action. An implicit action based upon that action would be accessing www.cnn.com/tech, with one degree of generalization, or accessing www.cnn.com, with two degrees of generalization. Accordingly, the implicit action correlation, demonstrates the correlation between the explicit action in a actor's tail and these generalized actions. The strength of the correlation between an implicit action and an explicit action is often based upon the degree of generalization required. For example, an explicit action might be more closely correlated to www.cnn.com/tech than it is to just www.cnn.com.

The data calculated from performing the previous three actions for each performance in the actor's tail is stored for subsequent use in generating the actor's recommendations. In particular, this data can be used to find other people that have performed a similar series of actions. This data can also be stored as part of the community data to indicate what the community typically does. In this situation, the identifying actor information is generally stripped out and only the action and action correlation information is retained.

Once the previous three steps have been calculated for each performance in the actor's tail, the practice variable can be adjusted. The practice variable indicates the relationship between an actor and an action that the actor has performed. Its strength is determined by the frequency and how recently the actor performs the action. The practice variable is unique to a particular actor, because it reflects the frequency with which an actor performs a particular task as well as the importance of the particular task. Practice variables can exist both for explicit actions and for implicit actions. Accordingly, the practice variable can be adjusted for both implicit actions and explicit actions. (Block 260, 265)

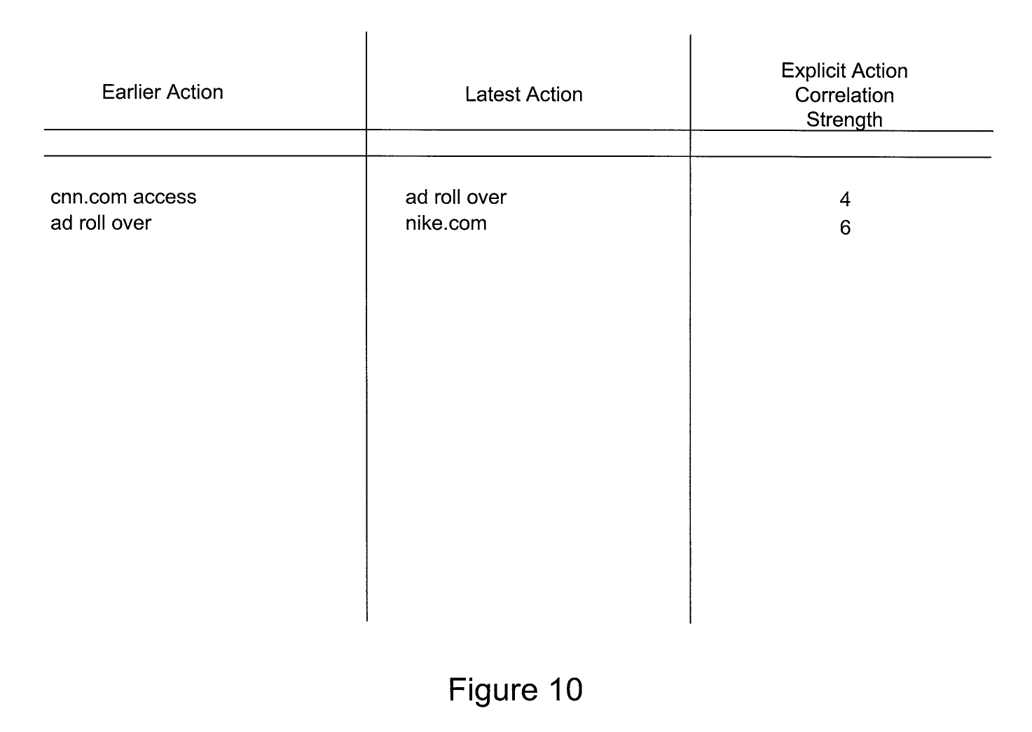

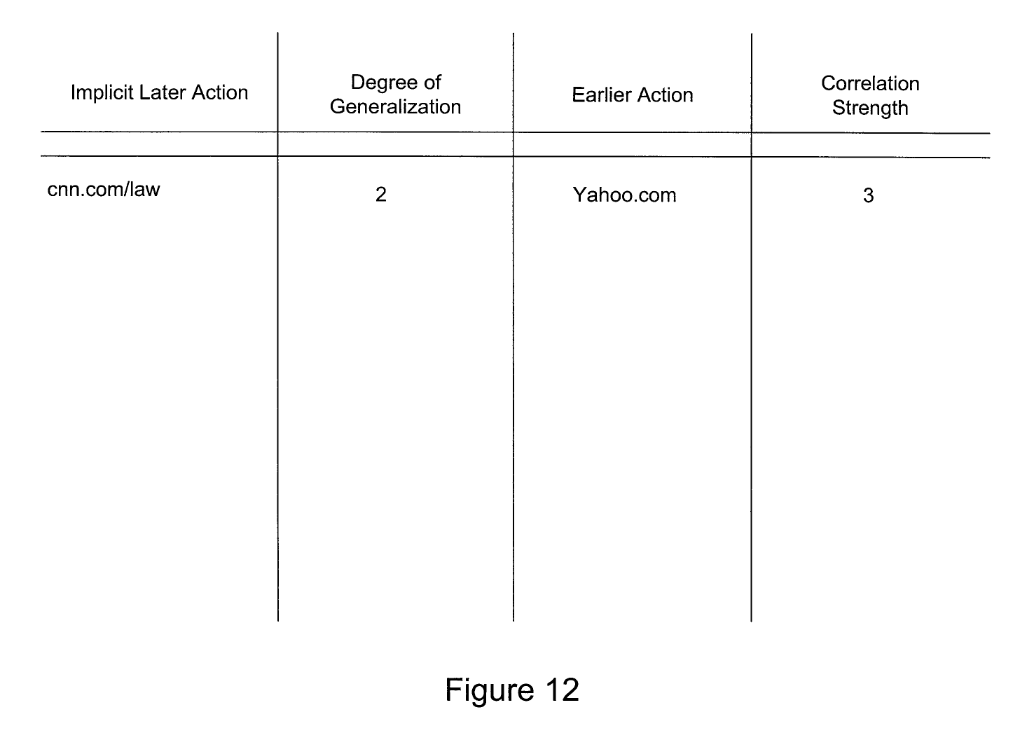

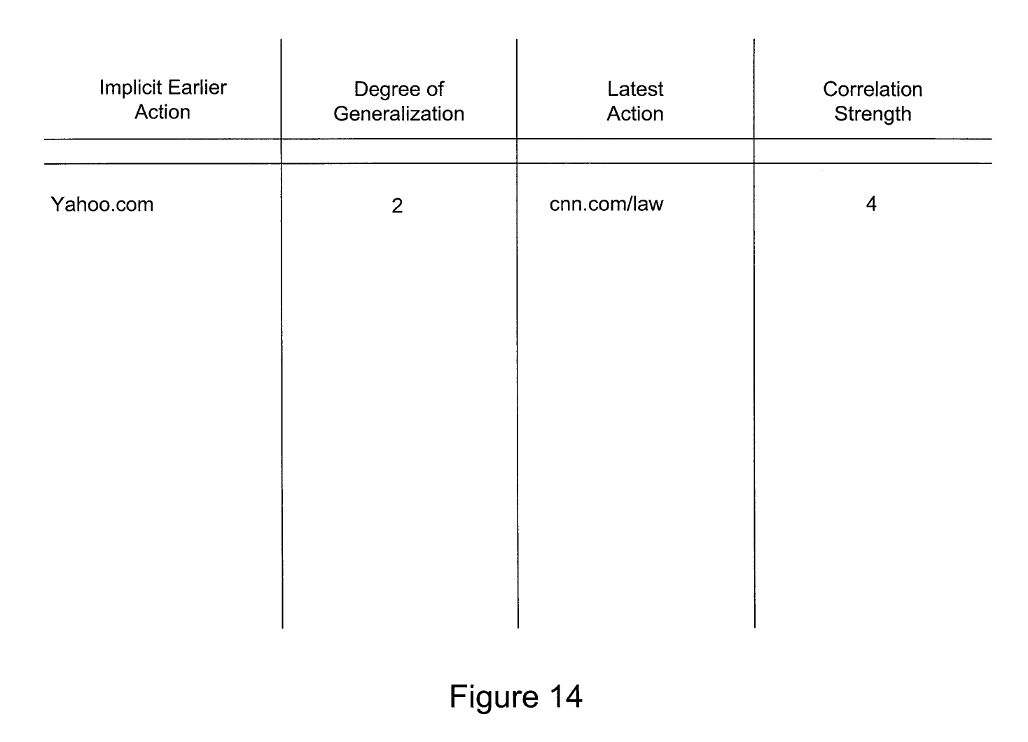

Finally, the correlation variables such as practice and importance can be written out to a community data file, which represents the collective actors' data and the correlations. (Block 270) In this document, the data file is also referred to as the graph. The graph can be any type of data structure, but for simplicity it is described as a table herein. Exemplary graphs are shown in FIG. 10, FIG. 12 and FIG. 14.

Additionally, the actor's tail can be amended to include the actor's most recent performance and the calculated strength data. (Block 275) In this embodiment, the actor's tail could include several components referred to as session tails. For example, if a user had two web browsers open, the actions performed in each web browser together would make up the actor's tail. However, within the actor's tail the actor would have two session tails, one corresponding to each web-browser session and activities in each web-browser session would be recorded in the corresponding session tail. By maintaining separate session tails, this embodiment of the invention allows recommendations to be generated that are specific to a particular web-browsing session.

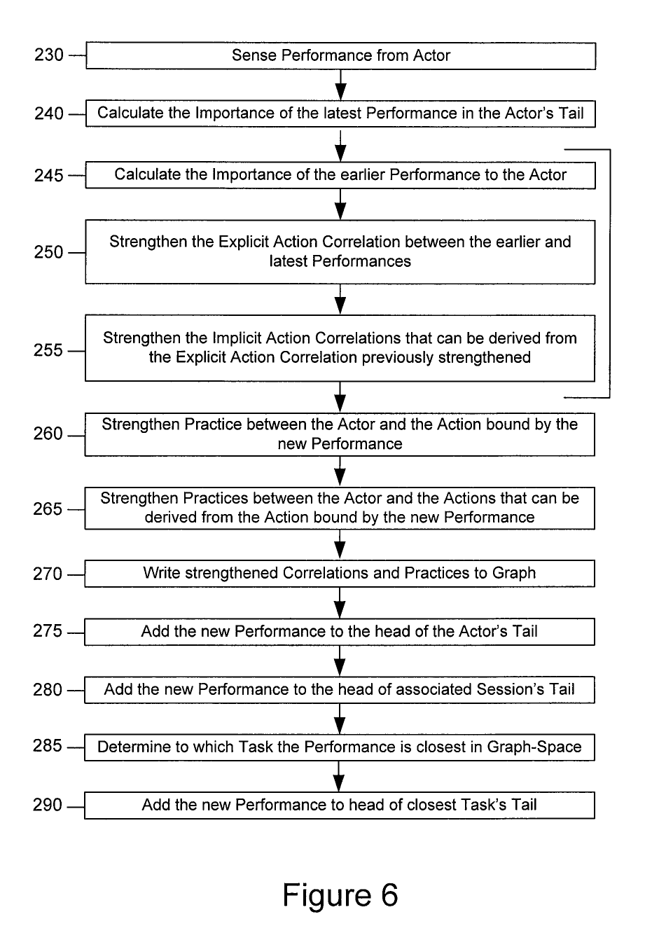

Referring now that FIG. 6, it is a similar embodiment to FIG. 5. One key difference, however, is that FIG. 6 accounts for multitasking differently than does the embodiment shown in FIG. 5. FIG. 6 is directed to an embodiment in which the various actions performed by an actor are sorted according to the different task being carried out by the actor.

The main variation between FIG. 6 and FIG. 5 arises at the step of adding the new performance to the head of the actor's tail. In this embodiment, the new performance performed by the actor is added to the complete list of user actions, which is contained in the actor's tail. (Block 275) The new performance is then also added to the associated session tail. But in this embodiment, the new performance is also added to the appropriate actor's task tail. (Block 280)

An actor can have several task tails simultaneously. Accordingly, the appropriate task tail for the most recent performance must be identified prior to adding an entry. (Block 285, 290) This process is described in detail in subsequent flow charts. In essence, the task tail represent clusters of performances from the actor's complete tail that make up a particular task.

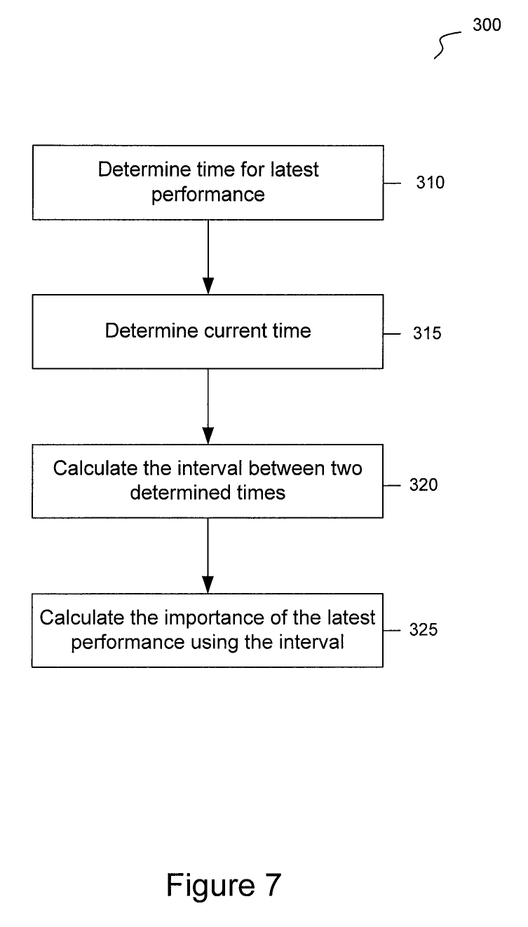

Referring now to FIG. 7, it illustrates a method 300 for calculating the importance of the actor's latest performance. This method corresponds to block 240 in FIG. 5 Initially, the time for the latest performance is determined. (Block 310) This step can be performed at the actor's computer or at the recommendation engine. The next step is to determine the current time. (Block 315) Again, this step can be performed at the actor's computer or the recommendation engine. Using these two determined times, the time interval is calculated. (Block 320) This calculated interval can then be normalized and used as an input for calculating the importance of the actor's latest performance. (Block 325) In some embodiments the time interval in the only input used to calculate the importance of the latest performance. In other embodiments the time interval is used in conjunction with other variables such as action type to calculate the importance of the user's latest action. Generally, this importance number is expressed as a number such as a number between 1 and 10.

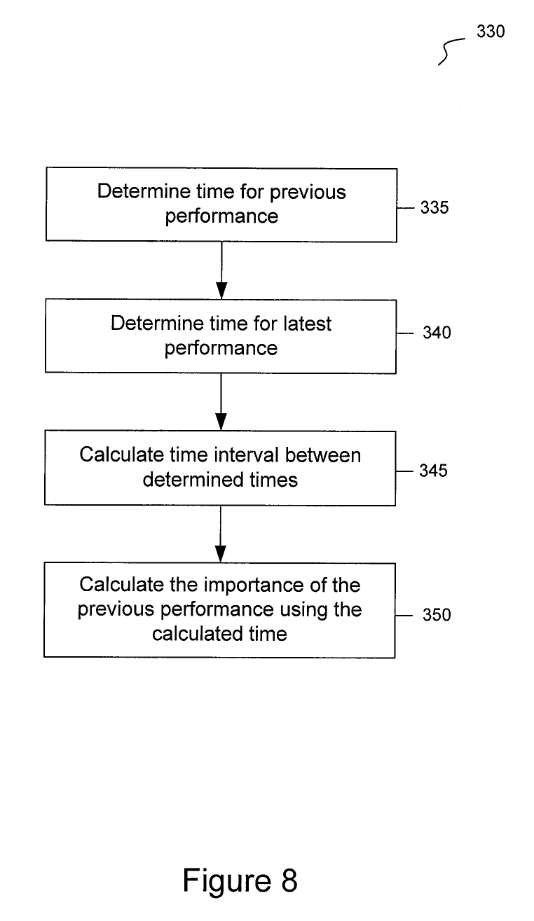

Referring now to FIG. 8, it illustrates one method 330 of calculating the importance of an actor's previous performances. As discussed in FIG. 5, these steps are generally performed for each previous performance in a actor's tail. In this method, the time for the previous performance is determined. (Block 335) Similarly, the time for the latest performance is determined. (Block 340) Using those two times the interval between the previous performances and the latest performance are determined. (Block 345) Using that calculated time interval, the importance of the previous performances can be calculated. (Block 350) Again, the importance of the previous performances can be based on not only the time interval data but also data with regard to action type and other similar data.

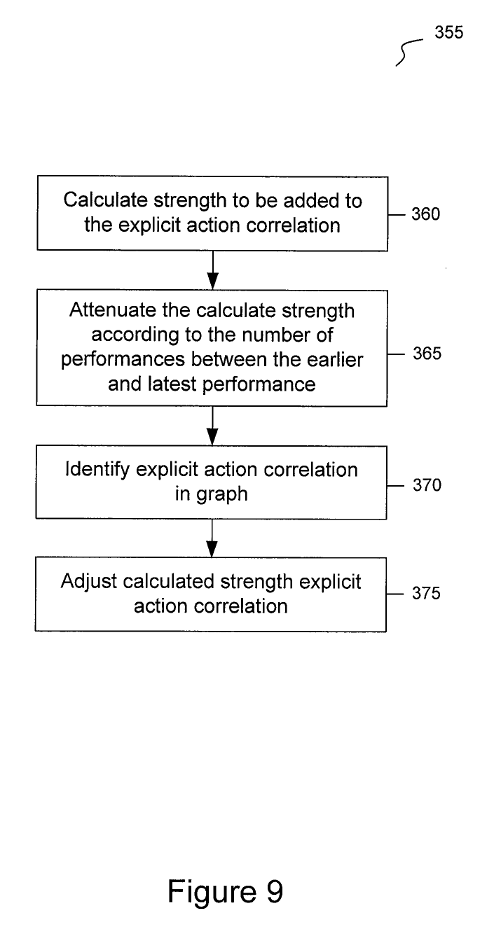

Referring now to FIG. 9, it illustrates one method 355 of strengthening explicit correlations between actions. This method corresponds to the step 250 shown in FIG. 5. For illustration purposes, the method shown in FIG. 9 can be considered in conjunction with the chart illustrated in FIG. 10.

The first step in this method involves using the performances' numbers that were previously calculated. (Block 360) The steps described in FIG. 9 are carried out for each earlier performance in the actor's tail. So for each earlier performance, the importance of that earlier performance is added to the importance of the latest performance. That combined number, or other indicator, is then adjusted to reflect the number of performances between the earlier performance and the latest performance. (Block 365) For example, the calculated strength of an earlier performance can be adjusted downwards—to be less important—if six other performances are between the earlier performance being considered and the most recent performance. In essence, this process allows older performances to be discounted as being less relevant. Once the adjusted strength number has been calculated, the data structure with the actor's performance data can be accessed. (Block 370) In this example, that data structure is a table, which is illustrated in FIG. 10. This newly calculated correlation number can be added to the appropriate data record in the table. This data record would then be updated every time a near performance is performed—meaning that older performances continually become less important. (Block 375)

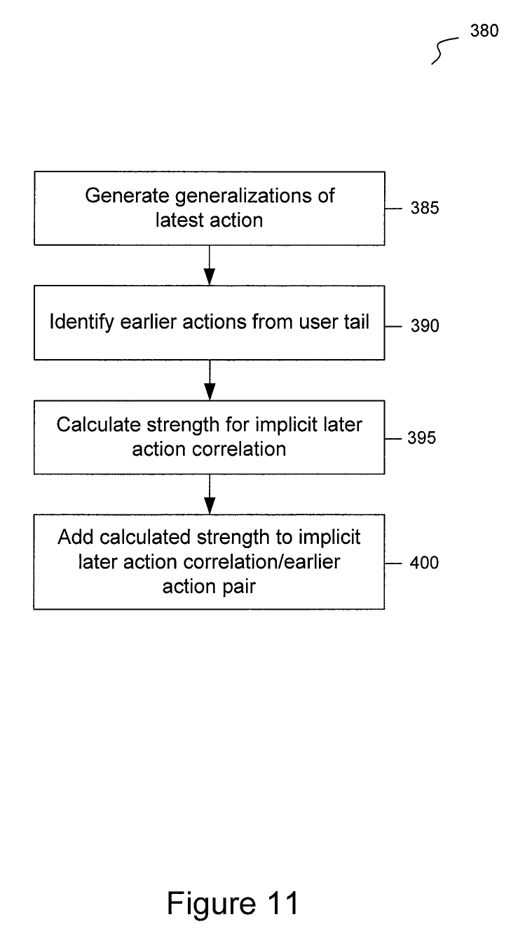

Referring now to FIG. 11, it illustrates a method 380 of strengthening the implicit action correlations between an implicit later action and an explicit earlier action. This method corresponds to step 255 in FIG. 5.

Typically, this process begins by generating generalizations of the latest action performed by an actor, which corresponds to the latest performance. (Block 385) As previously discussed, a generalization for accessing the website www.cnn.com/tech/space could be accessing www.cnn.com/tech and another generalization would be accessing www.cnn.com. Not all generalizations need be calculated for every action. The system can include a limiter that only generates a certain number of generalizations for any action.

Next, the earlier actions from the actor's tail are identified. (Block 390) Then the strength between each of these earlier actions and the generalized latest action is calculated. (Block 395) This strength could include information such as time intervals, action types and degree of generalization for the latest action. Finally, the calculated strength number can be added to the corresponding entry in an implicit later action correlation table. (Block 400) An exemplary implicit later action table is shown in FIG. 12. As previously described any data structure could be used, the table is just shown for convenience.

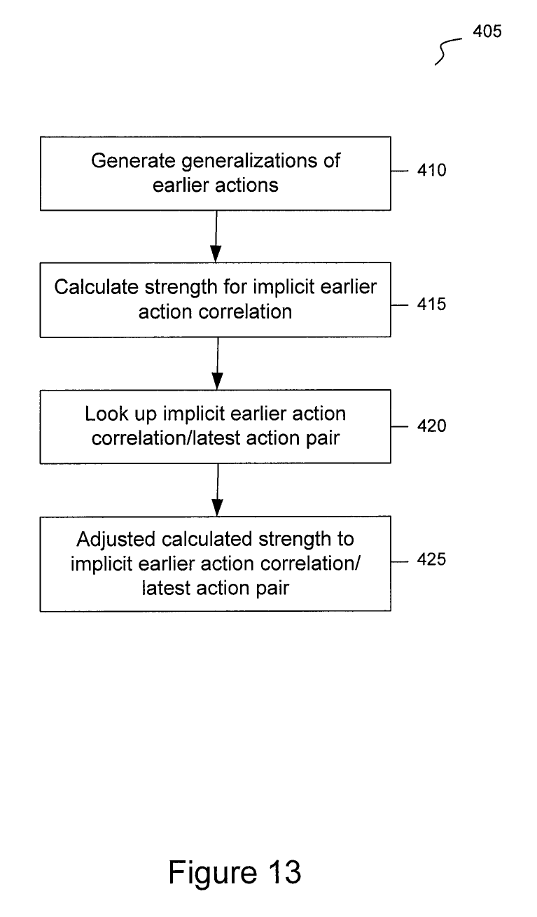

Referring now to FIG. 13, it illustrates strengthening the implicit action correlation 405. This method corresponds to blocks 255 in FIG. 5 and to FIG. 14. This method is very similar to the method described with regard to FIG. 12. The primary difference in that this method generates correlations between generalized earlier actions and the actual latest action performed by the user. In this embodiment, the initial steps involves generating the generalization of the earlier actions. (Block 410) For each of these generalizations, the strength is then calculated for the generalized earlier action and the actual or explicit later action. (Block 415) Finally, the implicit earlier action and the latest action paired or identified in the chart shown in FIG. 12 and the correlation strength is adjusted. (Block 420, 425) This process is performed for each generalized earlier action in an actor's tail.

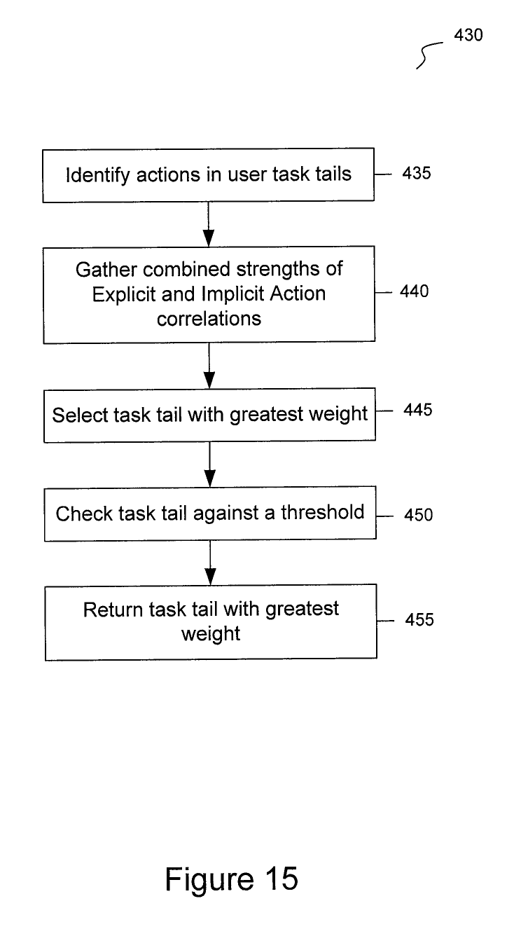

Referring now to FIG. 15, it illustrates an adjustment for multitasking that can be implemented in certain embodiments 430. This method corresponds to block 285 in FIG. 6. This method results in setting up multiple task tails for an actor, which allows seemingly separate actions from a linear list to be grouped into logical groups or tasks. Once an actor's task tails are established, the question becomes how to assigned new performances to the correct task tail. This method addresses these issues.

Initially, the actor's task tails are identified and retrieved. (Block 435) For each task tail, the strengths of the implicit and explicit correlations between the new performance's action and each action in the tail are combined to determine the degree to which the new performance is correlated with the task tail. (Block 440) This number can be weighted to adjust for time factors or other relevant information. The end result is that each task tail will be associated a strength number. Assuming that the strength number is greater than some minimal threshold, then the task tail with the highest strength number most likely corresponds to the users most recent performance. (Block 445, 450) Accordingly, the actor's most recent performance is added to that task tail. (Block 455) Alternatively, the actor's most recent performance is added to any task tail that corresponds to a strength number greater than a threshold.

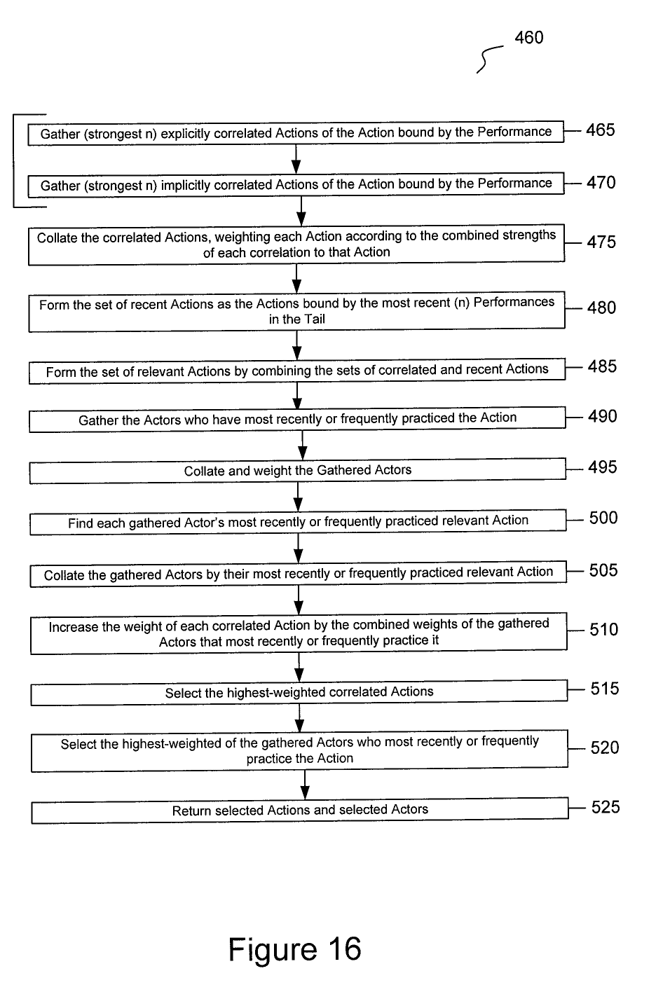

Referring to FIG. 16, it illustrates one method 460 for making a recommendation to an actor using information gathered about an actor's performances. The recommendation could include the identity of another actor, the identity of a group of actors, an indication of what another actor is currently doing, an indication of what another actor previously did, an indication of what another actor frequently does, or any combination thereof.

In this method, relevant actions for an actor are identified. These relevant actions (or just a single action) could be simply the last action performed by the actor or it could be a set of actions previously performed by the actor. For example, the relevant action could be selected from the actor's tail based on recency, frequency, or the correlation number.

In this embodiment, the first two Blocks (465, 470) are repeated for each performance in an actor's session tail or task tail to identify correlated actions. The first block involves gathering the strongest explicitly correlated actions connected to the actor's most recent performance. (Block 465) This information could be retrieved from the record created for the actor. The second step involves gathering the strongest implicitly correlated actions corresponding to the actor's most recent performance. (Block 470) This information could be retrieved from the record created for the actor.

The gathered explicit actions and implicit actions can then be combined. For overlapping actions, the weights assigned to those actions can be added together. (Block 475) The most recent actions performed by the actor can then be added to the gathered actions, thereby forming a set of relevant actions. (Blocks 480, 485) This list of relevant actions can then be sorted according to importance, weight, frequency, recency, or other. In certain embodiments, the list of relevant actions is reduced to a set number of relevant actions.

The next series of steps involve identifying other actors who have performed actions similar to the identified relevant actions. (Block 490) For each of the relevant actions determined in the previous steps, other actors who have performed these steps are identified. For example, the records for other actors can be searched for the identified relevant actions.

Alternatively, the next series of steps could identify actions that correspond to the identified relevant actions. In one embodiment, community data, which reflects the actions of all actors and the correlation of those actions, can be searched to identify actions that are correlated to the identified relevant actions. For example, the other actors could have performed the identified actions in conjunction with the relevant actions identified in Blocks 480 and 485. These sets of actions would be correlated—as described previously. These actions performed in conjunction with the relevant actions could then be used to search for other actors to list in the recommendation.

Referring again to FIG. 16, the identified actors can then be sorted by relevance. (Block 495) For example, the actors can be grouped according to who most recently performed the relevant actions, those who most frequently perform the relevant actions, those who performed the most relevant actions, or any combination thereof. The top actors can then be selected from the sorted list of actors. In some embodiments, a selected number of these top actors form the list of relevant actors. In other embodiments, the entire list of identified actors makes up the list of relevant actors.

In one embodiment, the previously-performed actions performed by the identified actors are collected and aggregated. (Block 500) This aggregated list of actions can then be sorted according to the actions performed by the most actors, the actions performed most frequently, the actions performed most recently, or any combination thereof. (Block 505, 510) This sorted list can then be used to identify most relevant actors. (Block 515) These actors can form part of the recommendation provided to the actor. (Block 520, 525)

In another embodiment, for each relevant actor, or at least a subset of the actors, the individual actor tails for those actors are retrieved. And for each of those actors, the most recently, frequently, and/or highest-rated relevant actions are identified. These actions can be identified using the correlating strengths stored in the implicit correlation charts and the explicit correlation charts for each of the actors.

Using these identified actions, the actors can then be grouped and sorted based upon the recency and/or frequency that they practiced the identified actions. For example, the weight of the correlated actions from other actors can be added up to identify the actions performed most frequently/recently by other actors. The highest weighted actions can then be selected. For each of these selected highest weighted actions, the actors who most recently and/or frequently performs those actions can be identified. The list of actors and actions can then be returned to the original actor as a recommendation.

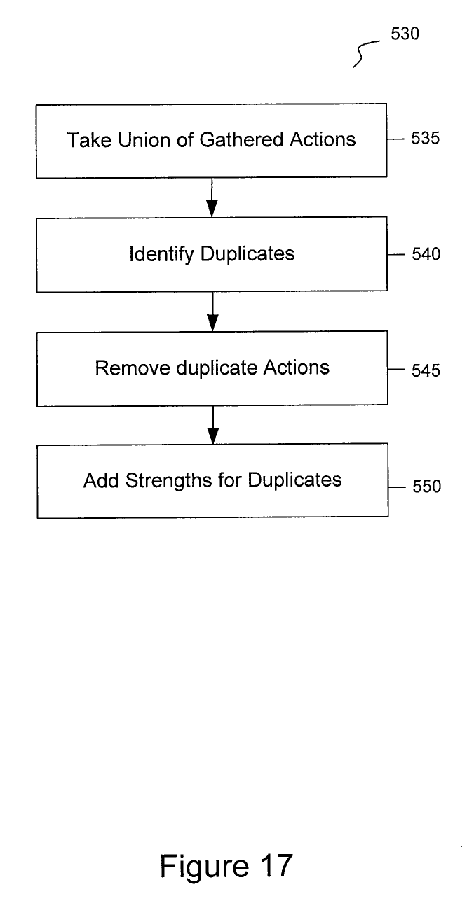

FIG. 17 illustrates a method 530 of forming the set of relevant actions. This process corresponds to block 485 in FIG. 16. Initially the gathered actions are retrieved from the various data structures. Taking the union of those tables, duplicate actions are identified. (Block 535) The duplicate actions are removed. (Block 540, 545) But the strength from the duplicate actions are added up to reflect a single entry for an action but a combined strength. (Block 550)

In some embodiments, privacy control is provided to the actors. In these embodiments, actors can share their actions and identities with other users; share their actions, but not their identities; share their identities, but not their actions; share actions and/or identities with selected people only; share nothing. Similarly, the actor can make similar choices about sharing information with the recommendation engine. When the actor elects not to share identity information, the actors actions can still be collected for the community data. In other embodiments, the actor can hide its current action from other users, but not its complete identity. In this embodiment, the actor can be identified as someone performing related tasks, but the tasks being performed by the actor will not be identified to other actors or will be identified only to select actors.

For security purposes, action collection and actor identification can be automatically turned off whenever an actor performs a secure action, including visiting a secure web site (banking sites, e-mail, and any other pages where entering a user-name and log-in are required) and any action identified as a secure or private action by that actor. In these types of systems, the recommendation engine may receive an indication that the actors was performing a secure action. At that point, the action collection process could be terminated or suspended. Alternatively, the action collection process would continue, but the information would not be shared with other actors.

In conclusion, embodiments of the present invention provide, among other things, a system and method for protecting privacy when generating recommendations based on an actor's actions. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for protecting secure information when tracking actions used to generate recommendations, the method comprising:
collecting explicit actions performed by a plurality of secondary users;
collecting implicit actions performed by a plurality of secondary users;
calculating the correlation between the explicit action and the implicit action;
generating a record of the collected explicit actions, the collected implicit actions, and the corresponding calculated correlations;
receiving an indication of a first action from a primary user;
identify a second action from the generated record that is correlated with the first action;
identifying a secondary user from the plurality of secondary users that has performed the second action;
determining whether the secondary user is performing a secure action; and
if the secondary user is not performing a secure action, providing a recommendation to the primary user, the recommendation including an identification of the secondary user.

2. The method of claim 1, further comprising:
determining at least one action performed by the secondary user;
wherein the recommendation further includes an indication of the determined at least one action.

3. The method of claim 1, wherein identify a second action comprises:
identifying at least one of an explicit action and an implicit action.

4. A method for protecting secure information when tracking actions used to generate recommendations, the method comprising:
receiving an indication that one of a plurality of secondary users is performing a secure action;
collecting actions performed the plurality of secondary users, not including the one of the plurality of secondary users;
calculating correlations between the collected actions;
generating a record of the collected actions and the corresponding calculated correlations;
receiving an indication of a first action from a primary user;
identify a second action from the generated record that is correlated with the first action;
identifying a secondary user from the plurality of secondary users that has performed the second action; and
providing a recommendation to the primary user, the recommendation including an identification of the secondary user.

5. The method of claim 2, further comprising:
determining at least one action performed by the secondary user;
wherein the recommendation further includes an indication of the determined at least one action.
